(19) United States
(12) Patent Application Publication
(10) Pub. No.: US 2004/0128232 A1
(43) Pub. Date: Jul. 1, 2004

(54) Mortgage prepayment forecasting system

(76) Inventor: Paul Descloux, Ossining, NY (US)

Correspondence Address: McGLEW AND TUTTLE, P.C., Counselors at Law, SCARBOROUGH STATION, SCARBOROUGH, NY, 10510-0827, US

(21) Appl. No.: 10/654,549

(22) Filed: Sep. 3, 2003

Related U.S. Application Data
(60) Provisional application No. 60/408,203, filed on Sep. 4, 2002.

(51) Int. Cl. G06F 17/60

(52) U.S. Cl. 705/38

(57) ABSTRACT

A system and method of the invention data from one or more title plants is obtained, with the data including but not limited to the approximate date of the outstanding mortgage origination, a zip code of the property, a street address, the originator of the loan, the loan size and other data where applicable. The data are linked to a title inquiry relating to a new loan, which is under consideration by the mortgagor. The method and system then associate the data from one or more title searches to an outstanding mortgage portfolio. Loan portfolio data is provided from one or more holders of a loan portfolio (servicing portfolio). A comparison of the title data obtained is made with data from the servicing portfolio, preferably without giving up any information as to the mortgagor.

### CROSS REFERENCE TO RELATED APPLICATION

This is a regular application claiming the benefit of Provisional Application No. 60/408,203 filed Sep. 4, 2002, the contents of which are incorporated by reference.

### FIELD OF THE INVENTION

The invention relates generally to a system and method of forecasting mortgage prepayments or more particularly United States residential loan satisfactions based on the use of available data to provide the holder of a mortgage portfolio with information as to the termination of mortgages in the portfolio.

### BACKGROUND OF THE INVENTION

Banks and other mortgage companies, which hold a portfolio of existing residential mortgages, are necessarily interested in determining which mortgages will be prepaid. Such a mortgage prepayment or satisfaction of an outstanding loan presents a change to the portfolio. These mortgage companies and banks are interested in the status of their portfolio and are interested in knowing the number and types of loans that will soon be prepaid. Such mortgage companies and banks wish to have information about changes including the loss of loans of a particular type, size or, interest rate.

It is most often the case that the prepayment of a mortgage takes place at the time that a new mortgage is commenced or some other action occurs which affects the title of the underlying property. The status of the title of a property is typically investigated as a step taken prior to a sale of a property or a refinancing of a mortgage.

Title plants are used by abstractors, title insurers, title insurance agents, and others to determine ownership of and interests in real property in connection with underwriting and issuance of title insurance policies and for other purposes. The use of such title plants and the access to title information may provide an indication as to upcoming prepayments of mortgages.

### SUMMARY OF THE INVENTION

It is an object of the invention to provide a method in system of using title information, particularly information from title plants to present information to entities having a loan portfolio so as to accurately indicate a number on loan satisfactions or mortgage prepayments which will occur within some upcoming timeframe. It is further an optional feature of the system and method of the invention that the information is provided to the owner of a loan portfolio without use of confidential information, particularly avoiding extensive use of confidential information including name of the mortgagee, the Social Security number of the mortgagee and other sensitive information.

According to the invention a system and method are used which considers data generated at the beginning of the mortgage process, particularly title reports. Such title reports are statistically analyzed to forecast U.S. mortgage prepayments, particularly U.S. residential, single-family mortgage prepayments.

According to a preferred form of the system and method of the invention data from one or more title plants is obtained, with the data including but not limited to the approximate date of the outstanding mortgage origination, a zip code of the property, a street address, the originator of the loan, the loan size and other data where applicable and/or provided. The data are linked to a title inquiry relating to a new loan, which is under consideration by the mortgagor. The method and system then associate the data from one or more title searches to an outstanding mortgage portfolio. Loan portfolio data is provided from one or more holders of a loan portfolio (e.g.; servicing portfolio). A comparison of the title data obtained is made with data from the designated portfolio, preferably without giving up any information as to the mortgagor.

The data used to form a match may include one or more of:

Approximate date of the outstanding mortgage origination

Zip code

Street address

Originator

Loan Size

Other data where applicable to match a title inquiry to a loan, which is under consideration by the mortgagor for satisfaction or payoff.

According to the invention, title data is collected on a periodic basis, for example a weekly basis. The loan portfolio data is provided from the mortgage portfolio holder and may be updated periodically. A comparison is made between the mortgage portfolio holder data and the title data received for the time period. Based on his comparison a list of a number of matching outstanding loans is generated. This may be presented as a time series of the number of loans as identified. The loans may also be further categorized based on the type of the loan. The method and the system of the invention subsequently makes a calculation as to the most likely time for the loan to close. This may be an estimation and is preferably based on prior statistical information. The calculation preferably assumes that all loans for which a title search has been generated result in the satisfaction of the outstanding loan. The method and system preferably include a forecasting of the expected changes as to prepayments for mortgage loans based on the number of title searches received for particular loan type. Further, based on the match of the loans from the portfolio to title data the system and method may provide for an indication as to prepayments with respect to one or more of the following loan types (but not limited to these types:

Fannie Mae/Freddie Mac conventional loans

FHA/VA (HUD) loans

Sub-prime/Alt A loans

Jumbo loans.

The information from one title plant may be analyzed on a loan type and location basis to forecast the prepayments of similar loans in a portfolio wherein no direct comparison to tile data has been made. Such statistical forecasting can be used in several ways as further described below. Loan identification can be done by either an exact, approximate, or elimination process. From the records of the loan portfolio holder the loan type of loan can be identified including:

Fixed-rate

30, 15, 20-year term, interest only

Adjustable rate

One-year conventional

5-year adjustable

7-year adjustable

Identification of the above loan types utilizing the methodology gives the ability to statically infer the following (but not limited to these):

Percentage of loans likely to prepay in the coming months;

Terms of loans likely to prepay in the coming months;

FICO score of loans likely to prepay in the coming months;

LTV of loans likely to prepay in the coming months;

Time since “in play” loan originated;

Time from initial mortgage application/title search inquiry to satisfaction of outstanding loan;

Type of activity: refinance, housing turnover, no action taken;

Effective refinance incentive. Interest rate differential between prevailing loan rate and satisfied loan;

Identification of streamline mortgagor behavior characteristics.

Because of the available history from one or more loan portfolios, and the availability of historical title data backtesting of the loan holders portfolio can be executed.

The system and method present information as noted thereby allowing for the following decisions to be made by a subscribing client.

Exacting knowledge of what types of loans are subject to early prepayment

Benchmarking of current prepayment model

Better hedging/hedge ratio accuracy

More focused marketing strategies

Staffing, human resource allocation

New retention strategies.

The system and method of the invention provide useful factual information as to actual prepayments which will occur in a determinable timeframe and also provides a useful forecasting tool providing a very said that just as noted above. The invention can provide the system and method based on the use of limited data amounting to a portion of loans for a region or can be based on extensive data including data from multiple title plants as well as data from multiple loan portfolios.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic diagram showing important features of the system of the invention; and

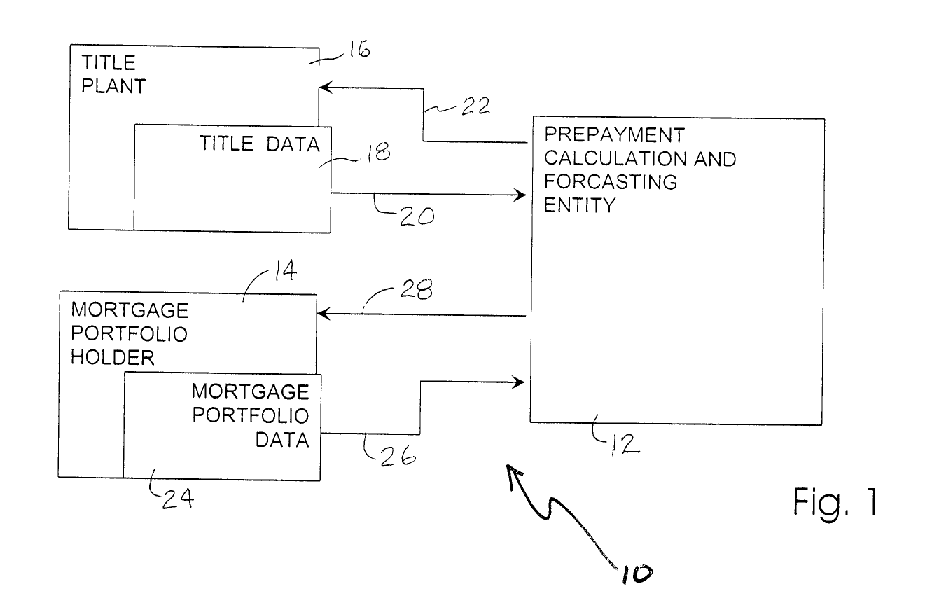

FIG. 2 is a flow diagram showing important aspects of the process of the invention.

### DESCRIPTION OF THE PREFERRED EMBODIMENTS

Referring to the drawings in particular, the invention comprises a system generally designated 10 with a prepayment calculation and forecasting entity 12 that provides a loan satisfaction information service to clients such as to a mortgage portfolio holder 14. The entity 12 may provide various different information services. The invention primarily concerns a method and system of providing information as to the loans held in portfolio holder's 14 portfolio that will be prepaid or a forecast of such prepayments.

According to the invention the entity 12 uses data which is either publicly available or obtains data from a company for a fee. A particularly advantageous form of the invention uses data from a title plant 16. The title plant 16 maintains data regarding the title of real property and provides information used by abstractors, title insurers, title agents and others to determine ownership of an interest in the real property in connection with underwriting and issuance of title insurance policies and mortgages. The company also maintains data as to title searches, namely the occurrence of an inquiry into the title of the particular property. The title plant 16 provides entity 12 with data relating to the occurrence of a title search or similar proceeding within some time frame such as one week. The data includes a data type which is at least one of the approximate date of an outstanding mortgage origination, the zip code of the property, the street address of the property, the originator of the loan (the original loan), the loan size, a loan type or other data where applicable to provide information to match the data to an existing loan held or managed by the mortgage portfolio holder 14. In exchange for providing the title data with the title data type at 20, the entity 12 may pay a fee as indicated at 22.

The entity 12 offers services to the mortgage portfolio holder 14. As a part of the services the mortgage portfolio holder 14 provides mortgage portfolio data 24 to the entity 12 as shown at 26. Advantageously according to the method and system of the invention the mortgage portfolio data 24 and the title data 18 may be a data type wherein at least one type coincides in order to make a comparison and detect matches as discussed further below. According to a particular advantage of the invention the data type does not include sensitive or confidential information relating to the individual or individuals that received the loan (the mortgagor). Specifically, it is particularly advantageous to exclude the name of the individual and the social security number of the individual as a data type. In this way, the invention provides a process which does not use confidential information.

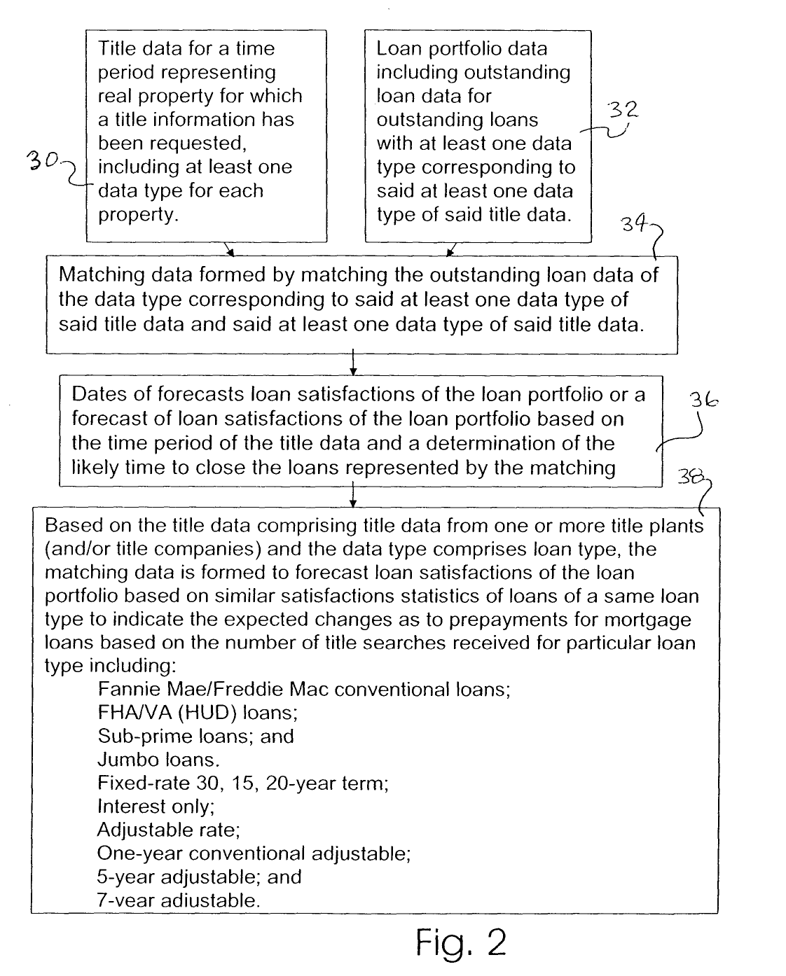

The process of the invention proceeds as shown in FIG. 2. As shown at step 30, title data 18 for a time period is provided from the title plant 16 to the entity 12. The title data 18 includes data of at least one data type, corresponding or representing the real property for which title information was requested during that data time period. Similar data 24 is provided by the portfolio holder 24 as shown at step 32. The data type does not need to have information that indicates a particular property and may instead indicate the type of the loan or other information which can be used for matching or otherwise forecasting loan prepayments to the mortgage portfolio holder data. If the geographic region is known, the data need not include specific property location information. Advantageously, the data 24 and 18 includes one or more of:

Approximate date of the outstanding mortgage origination;

Zip code;

Street address;

Originator;

Loan type;

Loan Size; and

Other data where applicable to match a title inquiry to a loan, which is under consideration by the mortgagor for satisfaction or payoff.

The loan portfolio data 24 relates to the outstanding loans of the mortgage portfolio holder 14. This data 24 and the title data 18 are compared by the entity 12 as shown at step 34 to formulate matching data. The matching relates to a one or more data type of data 18 matching one or more data type of data 24 for the time period corresponding to the title data period, such as one week.

The entity 12 applies this process to aggregated loans serviced by mortgage companies (servicing portfolio). The title data 18 can be matched to the servicing portfolio 14 without giving up the identity of the mortgagor.

The title data 18 is preferably collected weekly. From data files received, the number of outstanding loans, which have a possible match, is calculated. As shown at step 36 a time series of the number of loans as identified as a specific type is generated and an algorithm calculates the most likely time to close for the loan, and assumes that all loans for which a title search has been generated results in the satisfactions of the outstanding loan. This determination of dates of prepayment or forecasting, is provided to the portfolio holder as shown at step 38. The change in the number of title searches received for a particular loan type is used to forecast expected change in prepayments for mortgage loans. From loan files obtained from the mortgagee 14, the following type of loans can be identified such as: Fannie Mae/Freddie Mac conventional loans; FHA/VA (HUD) loans; Sub-prime loans; and Jumbo loans. Loan identification can be done by either an exact, approximate, or elimination process. From mortgagee loan files, the following type of loans can be identified such as fixed-rate 30, 15, 20-year term, interest only and Adjustable rate—One-year conventional, 5-year adjustable and 7-year adjustable.

Identification of the above loan types utilizing the methodology gives the ability to statically infer the following:

Percentage of loans likely to prepay in the coming months

Terms of loans likely to prepay in the coming months

FICO score likely to prepay in the coming months

LTV likely to prepay in the coming months

Time since “in play” loan originated

Time from initial mortgage application/title search inquiry to satisfaction of outstanding loan

Type of activity: refinance, housing turnover, no action taken

Effective refinance incentive. Interest rate differential between prevailing loan rate and satisfied loan.

Identification of streamline mortgagor behavior characteristics

Because of the available history that entity 12 generates, a backtesting of the portfolio can be executed subsequent to the determination or forecast.

The determination or forecast 28 by the entity 12 allows for the following decisions to be made by a subscribing client 14:

knowledge of what types of loans are subject to early prepayment may be exacted;

a benchmarking of the current prepayment model may be made;

better hedging accuracy may be attained;

a more focused marketing strategy may be formulated;

better decisions as to staffing and human resource allocation may be made;

new retention strategies may be devised.

Utilizing the same process as identified above, mortgagees who have a portfolio of secondary mortgage loans (second property liens) on a residence can utilize the title matching process to identify either specific second lien mortgage loans or the percentage of a portfolio of second lien mortgages loans likely to be satisfied. The characteristics of he loans can then be ascertained. The purpose of this application would allow mortgagees to understand the likelihood which second mortgage loans from a portfolio could be satisfied when a mortgagor with a second mortgage loan utilizes the origination of a primary mortgage to satisfy same mortgagor's outstanding second mortgage loan.

While specific embodiments of the invention have been shown and described in detail to illustrate the application of the principles of the invention, it will be understood that the invention may be embodied otherwise without departing from such principles.

What is claimed is:

1. A system for determining or forecasting upcoming mortgage prepayments, the system comprising:
title data for a time period representing real property for which a title information has been requested, said title data including at least one data type for each property;
loan portfolio data including outstanding loan data for outstanding loans with at least one data type corresponding to said at least one data type of said title data;
matching data formed by matching the outstanding loan data of the data type corresponding to said at least one data type of said title data and said at least one data type of said title data; and
dates of loan satisfactions of the loan portfolio or a forecast of loan satisfactions of the loan portfolio based on the time period of the title data and a determination of the likely time to close the loans represented by the matching data.

2. A system according to claim 1, wherein the title data includes one or more of the approximate date of the outstanding mortgage origination, a zip code of the property, a street address of the property, the originator of the loan, the type of loan and the loan size for each property.

3. A system according to claim 1, wherein the loan portfolio data includes one or more of the approximate date of the outstanding mortgage origination, a zip code of the property, a street address of the property, the originator of the loan, the type of loan and the loan size for each property of the loan portfolio.

4. A system according to claim 1, wherein the loan portfolio data and the title data do not include the name of the property owner and the social security number or other identification associated with the property owner.

5. A system according to claim 1, wherein the title data is compiled or obtained on a weekly basis from one or more title plants and compared to loan portfolio data from one or more loan portfolios on a weekly basis.

6. A system according to claim 1, wherein the dates of loan satisfactions of the loan portfolio or a forecast of loan satisfactions of the loan portfolio is provided by forming a time series of the number of loans from the matched data.

7. A system according to claim 1, wherein the matching data is categorized based on the type of the loan.

8. A system according to claim 1, wherein the dates of loan satisfactions of the loan portfolio or a forecast of loan satisfactions of the loan portfolio is based on an assumption that all loans for which a title search has been generated result in the satisfaction of the outstanding loan.

9. A system according to claim 1, wherein the title data comprises title data from a one or more title plants with the same geographic region as the underlying properties of the loan portfolio.

10. A system according to claim 1, wherein the title data comprises title data from a one or more title plants with a different geographic region as the underlying properties of the loan portfolio.

11. A system according to claim 1, wherein the title data comprises title data from one or more title plants and the data type comprises loan type to form matching data to forecast loan satisfactions of the loan portfolio based on similar satisfactions statistics of loans of a same loan type to indicate the expected changes as to prepayments for mortgage loans based on the number of title searches received for particular loan type.

12. A system according to claim 11, wherein the match of the loans from the portfolio to title data provides an indication as to prepayments with respect to one or more of the following loan types within a client's portfolio
Fannie Mae/Freddie Mac conventional loans;
FHA/VA (HUD) loans;
Sub-prime loans; and
Jumbo loans.

13. A system according to claim 11, wherein the match of the loans from the portfolio to title data provides an indication as to prepayments with respect to one or more of the following loan types:
fixed-rate 30, 15, 20-year term;
interest only;
adjustable rate;
one-year conventional;
5-year adjustable; and
7-year adjustable.

14. A system according to claim 11, wherein the match of the loans from the portfolio to title data is either an exact match, an approximate match or a match based on an elimination process.

15. A system according to claim 11, further comprising at least one of
a statically inferred percentage of loans likely to prepay in the coming months.
a statically inferred terms of loans likely to prepay in the coming months.
a statically inferred FICO score likely to prepay in the coming months.
a statically inferred LTV likely to prepay in the coming months.
a statically inferred time since “in play” loan originated.
a statically inferred time from initial mortgage application/title search inquiry to satisfaction of outstanding loan;
a statically inferred type of activity: refinance, housing turnover, no action taken;
a statically inferred effective refinance incentive;
a statically inferred interest rate differential between prevailing loan rate and satisfied loan; and
a statically inferred identification of streamline mortgagor behavior characteristics.

16. A system according to claim 1, further comprising:
comparing the known historical loan prepayments of a loan portfolio to the dates of loan satisfactions of the loan portfolio or a forecast of loan satisfactions of the loan portfolio, subsequent to the dates.

17. A method for determining or forecasting upcoming mortgage prepayments, the system comprising:
obtaining title data for a time period representing real property for which a title information has been requested, said title data including at least one data type for each property including one or more of the approximate date of the outstanding mortgage origination, a zip code of the property, a street address of the property, the originator of the loan, the type of loan and the loan size for each property;
obtaining loan portfolio data including outstanding loan data for outstanding loans with at least one data type corresponding to at least one data type of said title data including one or more of the approximate date of the outstanding mortgage origination, a zip code of the property, a street address of the property, the originator of the loan, the loan type and the loan size for each property of the loan portfolio;
matching the outstanding loan data of a data type corresponding to said at least one data type of said title data and said at least one data type of said title data; and
determining or forecasting dates of loan satisfactions of the loan portfolio based on the time period of the title data and a likely time to close the loans represented by the matching data.

18. A method according to claim 17, wherein the loan portfolio data and the title data do not include the name of the property owner and the social security number or other identification associated with the property owner.

19. A method according to claim 17, wherein the title data is compiled or obtained on a weekly basis from one or more title plants and compared to loan portfolio data from one or more loan portfolios on a weekly basis and the forecast for determination of loan prepayments is used to do one of:
provide exacting knowledge of what types of loans are subject to early prepayment;
provide a benchmark for a current prepayment model;
provide for better hedging accuracy;
provide for more focused marketing strategies;
staff an organization managing the loan portfolio; and
provide for new loan retention strategies.

20. A method according to claim 17, wherein the title data is provided to a loan prepayment calculation and forecasting entity that matches the outstanding loan data of a data type corresponding to said at least one data type of said title data and said at least one data type of said title data and determines or forecasts dates of loan satisfactions for a fee and the loan prepayment calculation and forecasting entity charges the loan portfolio manager or holder a fee for the determination or forecast.
